(19) United States
(12) Patent Application Publication
(10) Pub. No.: US 2004/0054573 A1
(43) Pub. Date: Mar. 18, 2004

(54) Smart content information merge and presentation

(76) Inventors: Samir Shah, Mountain View, CA (US); Binh Truong, Mountain View, CA (US); Ram Gupta, Cupertino, CA (US)

Correspondence Address: HEWLETT-PACKARD COMPANY, Intellectual Property Administration, P.O. Box 272400, Fort Collins, CO, 80527-2400, US

(21) Appl. No.: 10/229,851

(22) Filed: Aug. 28, 2002

(51) Int. Cl. G06F 17/60

(52) U.S. Cl. 705/14

(57) ABSTRACT

A method for merging information based on a user profile comprises selecting a template definition file, reading the selected template definition file, selecting at least one offer definition file with an extension indicated by the template definition file, reading each of the selected at least one offer definition files, ranking offers defined by the offer definition files, and presenting a hypertext mark-up language page with the ranked offers to a user.

### RELATED APPLICATIONS

The present invention is related to concurrently filed, commonly assigned, application Ser. No. ______ [Attorney Docket No. 10018268-1], entitled Smart Phonebook Search; and, application Ser. No. ______ [Attorney Docket No. 10018269-1], entitled Content Synchronization Frameworks Using Dynamic Attributes and File Bundles for Connected Devices; the disclosures of which are each incorporated herein by reference in their entireties.

### FIELD OF THE INVENTION

The present invention is broadly related to service delivery via a network and, more specifically, to smart content information merge and presentation.

### BACKGROUND

Existing applications that dynamically present data are typically resident on a synchronization server rather than on client appliances. Typically these applications employ predefined logic to interpret data and employ a predefined presentation logic. Therefore, existing applications do not provide true dynamic presentation.

Also, existing so-called dynamic data-presentation applications do not merge information to be presented to users based on an environment in which an appliance user is operating. Also, these existing dynamic data-presentation applications typically have limited scalability and flexibility to distribute data, software and other solutions.

### SUMMARY OF THE INVENTION

An embodiment of a method for merging and presenting content information comprises selecting a template definition file, reading the selected template definition file, selecting at least one offer definition file with an extension indicated by the template definition file, reading each of the selected at least one offer definition files, ranking offers defined by the offer definition files, and presenting a hypertext mark-up language page with the ranked offers to a user.

An embodiment of a content information merge and presentation system comprises at least one synchronization server, at least one content server, network connectivity providing data communication between at least one user device and the servers, at least one template definition file, at least one offer definition file, at least one hypertext mark-up language template, a client service delivery platform application running on the user device, the application merging the at least one template definition file, the at least one offer definition file and the at least one hypertext mark-up language template file to present an offers page for display by the user device.

Another embodiment of a method for merging content information comprises selecting a template definition file, reading the selected template definition file, selecting an offer definition file with an extension indicated by the selected template definition file, reading the selected offer definition file, determining whether all offer definition files with the extension indicated by the selected template definition file have been read, repeating, in response to a determination that all offer definition files have not been read, the selecting an offer definition file and the reading the selected offer definition file, ranking offers defined by the selected offer definition files, writing a hypertext mark-up language output file based on the offers and the ranking, determining if all of the template definition files have been read, repeating, in response to a determination that all template definition files have not been read: the selecting a template definition file, the reading the selected template definition file, the selecting an offer definition file, the reading the selected offer definition file, the determining whether all offer definition files been read, the repeating the selecting and reading an offer definition file, the ranking, and the writing; and presenting, in response to all template definition files having been read, a hypertext mark-up language page with the ranked offers.

### BRIEF DESCRIPTION OF THE DRAWING

FIG. 1 is a diagrammatical representation of a synchronization framework employing an embodiment of the present invention;

FIG. 2A shows an example Template Definition File (TDF) format in accordance with the present invention;

FIG. 2B shows an example offer definition file (ODF) format in accordance with the present invention;

FIG. 3 is a flowchart of creation of an information presentation by merging various content or other information from various servers or the like in accordance with the present invention;

FIG. 4 is a diagrammatical illustration of use of a TDF file, a hypertext markup language (HTML) template (HTMT) file, an ODF file, and Internet service provider (ISP) content and images to create HTML presentable data in accordance with the present invention; and

FIG. 5 is a diagrammatical illustration of an example of positioning offers on an HTML page based on highest business values in accordance with the present invention.

### DETAILED DESCRIPTION

The present invention is directed to systems and methods that provide a smart information merge and presentation component of a service delivery platform (SDP) application. The present invention is preferably employed after information is downloaded using content synchronization. This content synchronization may be carried out using the systems and methods disclosed in co-pending, co-owned application Ser. No. ______ [Attorney's Docket No. 10018269-1] entitled “CONTENT SYNCHRONIZATION FRAMEWORKS USING DYNAMIC ATTRIBUTES AND BUNDLES FOR CONNECTED DEVICES”. The SDP is preferably an application that provides value-added Internet-facilitated services and the like to users of various digital appliances and devices.

The present smart information merge solution is a client-based solution. Hence, it is particularly well suited for employment by connected devices and/or appliances. The present invention preferably separates content presentation style, business policies and/or parameters from content. Whereas, the present smart information merge invention is a client-based solution, it has sufficient flexibility to attach various degrees of arbitrary business and/or policy values and presentation styles to offers.

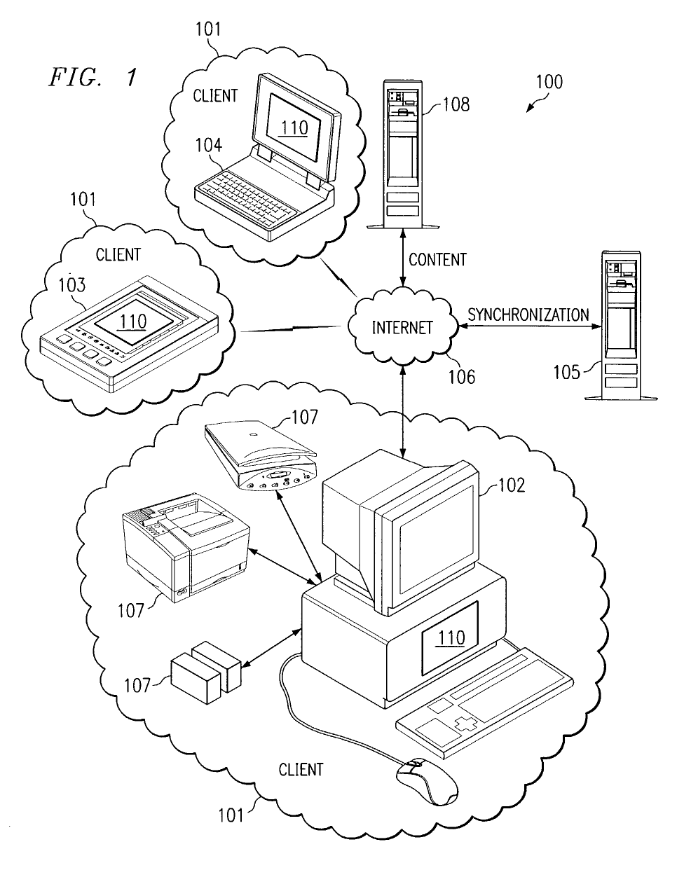

The SDP application preferably performs synchronization consistent with illustrated synchronization framework 100 of FIG. 1. Synchronization framework 100 allows various client appliances or devices 101, such as personal computer (PC) 102, handheld/palmtop appliance 103, portable computer 104, or the like, to download a variety of content, such as files, patches, graphics or the like from content server 108 and/or synchronization server 105 over a connected network, such as Internet 106. In accordance with an embodiment of the present invention, the synchronization process is preferably triggered seamlessly for devices connected to the Internet or having other network connectivity, without requiring user interaction.

According to a preferred embodiment of the present invention, synchronization is carried out based on context. Herein, “context” is used to mean criteria factoring into various attributes relating to and/or defining a device profile, such as an attached peripheral profile, a user profile, geographical locations, communication infrastructure and/or the like. These criteria may be user provided or automatically deduced, according to the present systems and methods, from the environment in which the device is operating

As shown in FIG. 1, by way of example, personal computer 102 is shown to have various peripherals 107 attached. In this example, when an SDP client application 110 performs synchronization of PC 102, SDP client application 110 provides server 105 information about the various peripherals 107 attached to personal computer 102. Based on business policies or the like defined on server 105 and by client environment, and based on various attributes of peripherals 107 and PC 102, server 105 preferably provides a list of value-added Internet-facilitated services, referred to herein as “offer bundles”, to be downloaded by client 101.

The present invention separates business policies and/or parameters pertaining to an offer and content presentation format from the content itself An “offer bundle” may contain various content such as an offer definition file (ODF), offer text and/or offer images, to be presented to a user. In accordance with the present invention, an ODF preferably contains a variety of arbitrary business policies and/or parameters pertaining to or associated with each offer. Preferably, a template definition file (TDF) contains a content presentation for each offer in accordance with the present invention. One TDF file may provide content presentation for a set of offers that fall into a same category. Preferably, a hypertext markup language (HTML) template (HTMT) file is a template that may be referred to during HTML generation of a page presenting offers. The present information merge logic refers to these three files (ODF, TDF and HTMT) and dynamically merges these files to create an HTML offer page for each offer that can be presented by SDP client application 110 in accordance with the present invention.

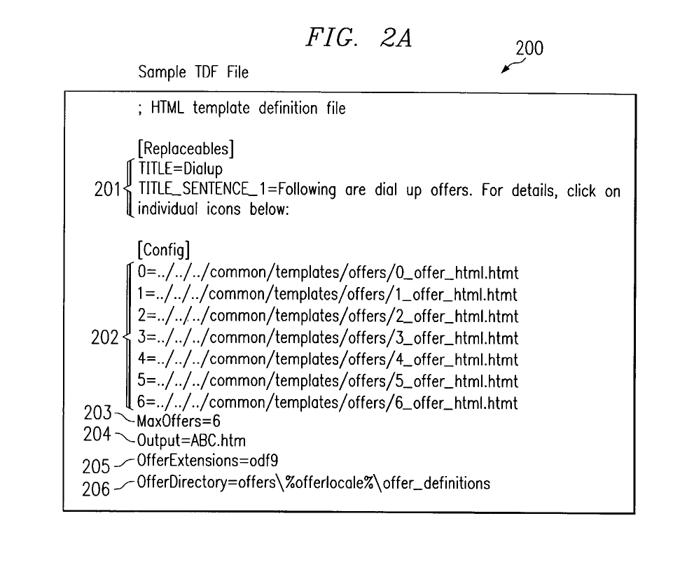

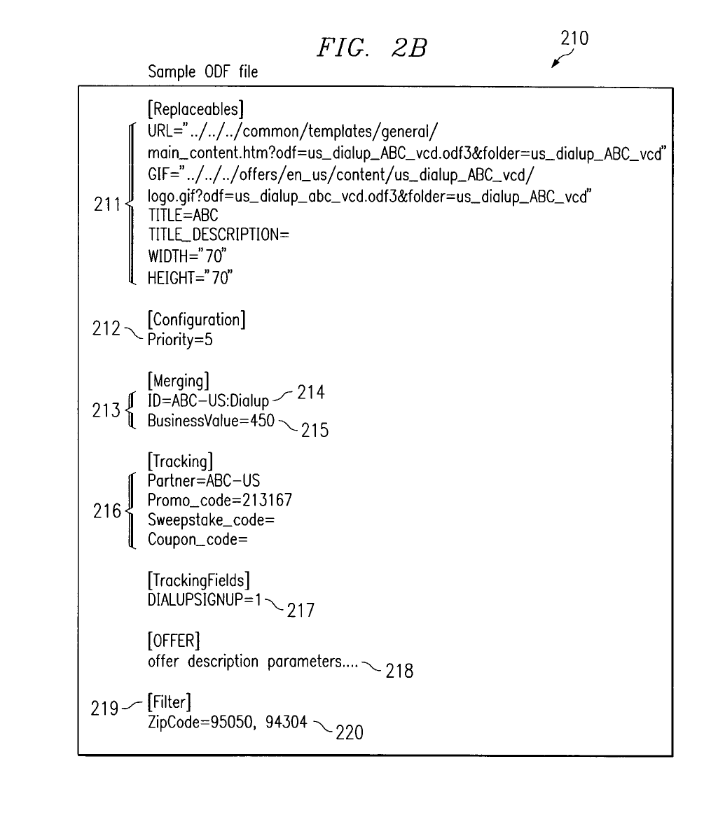

Turning to FIG. 2A, TDF 200 contains information about how offers are to be presented to the user. A title page that contains a list of all offers may have a description as defined at 201. The number of offers for a particular template is preferably dynamic and parameter 202 describes which HTMT to use when an offer count falls within certain parameters, as illustrated here by way of example to be zero to six. Maximum number of offers parameter 203 preferably informs the client application of a maximum number of offers that may be shown to the user at one time. Hence, TDF file 200 ensures that presentation logic remains dynamic and, depending on the number of offer bundles allowed at 203, that an appropriate presentation template is used. A final output HTML file name to be generated is set at 204. An ODF file extension at 205 preferably informs the client application of a class of offer bundles to be presented by current TDF file 200. Offer path parameter 206 provides a directory or network path of ODF files to the client application. Similarly, the client application preferably looks for all TDF files in the directory indicated at 206 and finds corresponding ODF files 210 for each TDF file 200.

Example ODF file 210 is shown in FIG. 2B. Section 211 preferably describes various parameters related to an individual offer. Parameter 212 preferably specifies to the client application a priority of download for this offer when synchronization is performed. Merging information is preferably provided at 213. Specifically, in a situation where there are multiple alike offers such as identical identification fields 214 for a given appliance and/or device, the present systems and methods preferably pick the offer that has a highest business value 215. This provides smart dynamic merging capability for presenting offers by the client application to a user in accordance with the present invention. Business value parameter 215 is preferably based on business/marketing importance of presenting a given offer to a given user. Also, business value 215 may be employed for positioning offers for presentation to users. For example, the highest business valued offer would preferably be positioned to attract maximum customer attention such as in the center of an HTML generated offer page. Business value may be determined by independent analysis by a business development personnel, or the like. However, embodiments of the present invention would allow an enterprise to purchase a high business value to assure that their product is prominently promoted and displayed. As described above, TDF file 200 determines a maximum number of offers that may be shown to the customer. Hence, if offers exceed maximum count 203 above, offers with lowest business values 215 in ODF 210 are preferably dropped. Preferably, tracking information provided at 216 and 217 uniquely identifies offer 218, which in turn may be used to signify selection by a user of offer 218. Additionally, each ODF can have dynamic parameters 219 or dynamic arbitrary attributes for filtering content, for example, a zip code filter 220 as shown may be used to show offers only when a user's postal zip code satisfies criteria in ODF file 210. Preferably, zip code filter 219 is dynamic. Any other arbitrary filter can be dynamically set for an offer (e.g., a user “age” filter can be set by providing an “Age=20-40” parameter or the like in ODF file “filter” section 220). These dynamic parameters are preferably processed in the client application without a server being involved in decision-making. Hence, filters 220 are client side dynamic filters that help reduce load on servers providing a scalable distributed synchronization solution.

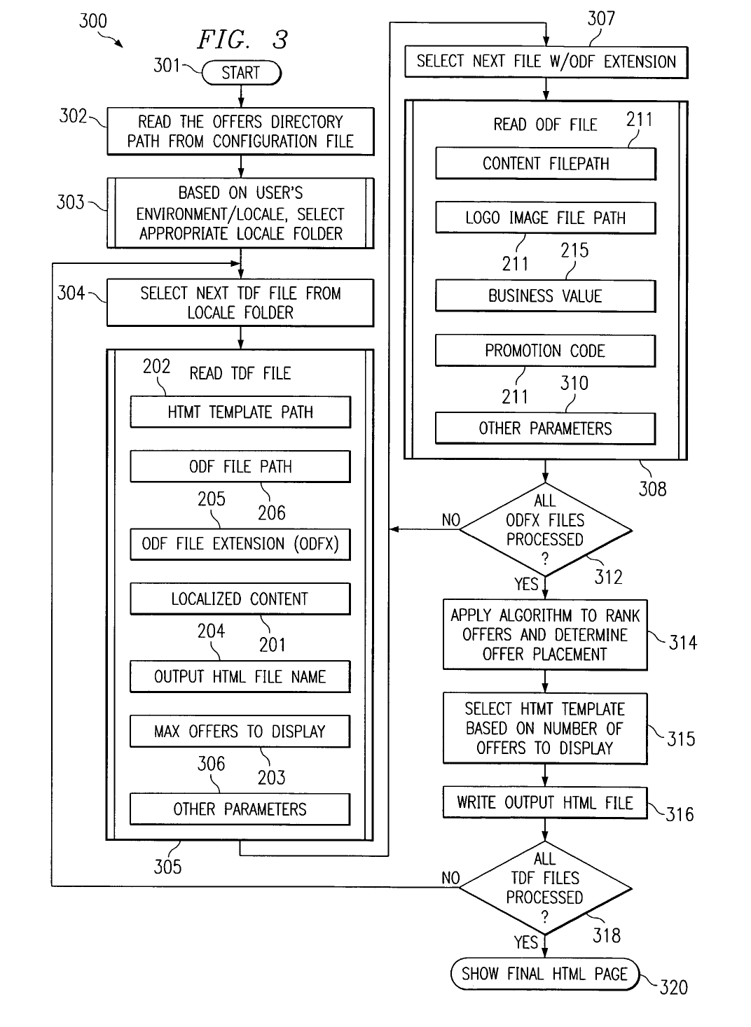

FIG. 3 is a diagrammatic flow chart of creation of a final HTML page, employing the aforedescribed ODF, TDF and HTMT files, for presentation to a user. The client SDP application generates an HTML offer page used to present offers from various content, employing method 300 or the like. Generation method 300 starts at 301 and at 302 a path for an offer directory that contains the TDF files is obtained from a configuration information file (e.g., an “.ini” file) associated with the local client SDP application.

Based upon the user or client's environment, including geographic location and/or language, the client SDP application selects a locale folder or the like at 303 that preferably contains context appropriate TDF files for the user and/or the user's appliance. A TDF file from the selected locale folder is selected at 304. Then the client SDP application reads each TDF file, box 305, to find various content presentation parameters, such as: a HTMT presentation template 202; a set of ODF files to be used, based on ODF file extension 205; number of offers to be displayed per page 203; output HTML file name to be generated 204; title for an offer bundle or other localized content 201; and other TDF parameters 306. At box 307 an ODF file extension (205) is selected, and at box 308, the client SDP application uses ODF files to gather individual offer parameters 211 including business value parameters 215 and other ODF parameters 310. Such parameters 211 may include content filepaths, image filepaths, promotion codes, a merge identification, an offer display priority, a promotion code, dynamic arbitrary filter attributes, a partner identification for tracking offers, a sweepstakes code, a coupon code, a type of offer, an offer pertaining to specific product line, a zip code, or the like.

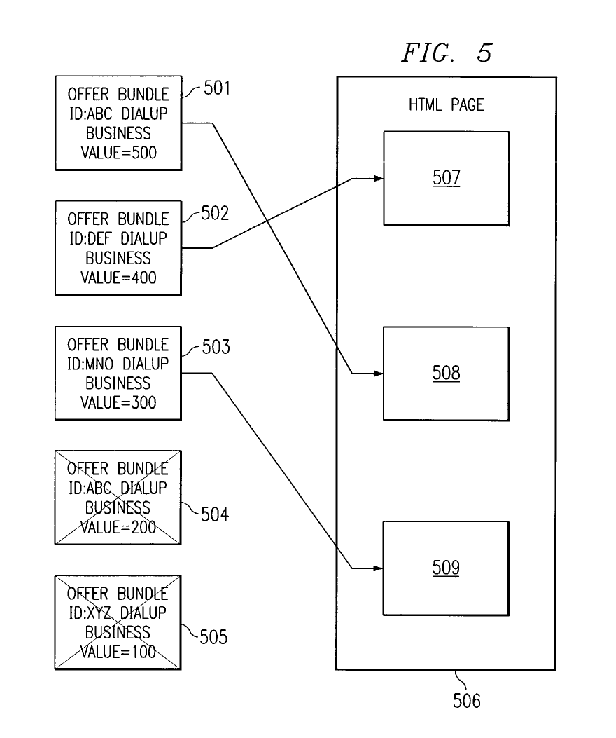

At 312, a determination is made as to whether all ODF files with the extension indicated by the TDF files at 205 have been read. If all files with indicated extensions have not been read at 312, then steps 307 and 308 are repeated, selecting a new extension at 307 and reading each ODF file with the newly selected extension at 308. The client SDP application determines placement of offers at box 314. As discussed in greater detail below in relation to FIG. 5, placement is preferably based, at 314, on business value 215 ranking collected at 308. Offers in excess of maximum number 203, collected at 305, are not placed. Based on the number of ODF files present or the maximum number 203 defined in TDF file 304, the client SDP application selects an appropriate HTMT file at 315. An HTML page is created including various offer elements, such as ODF file indicated content, at box 316.

A determination is made at 318 as to whether all the TDF files have been read, and thus their associated ODF files acted upon. If all TDF files have not been read at 318, then steps 305 through 316 are repeated for a next TDF selected at 304. If it is determined at 318 that all TDFs have been processed by the client SDP application, the final resulting HTML offer page is shown at 320.

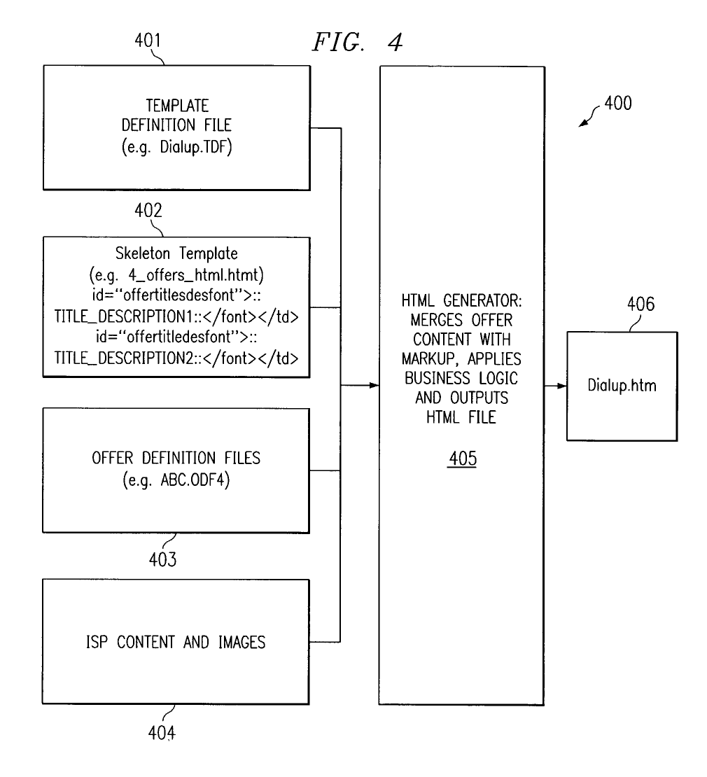

FIG. 4 diagrammatically illustrates HTML generation process 400. From TDF file 401, the SDP client application determines a list of ODF files 403 to be considered in creating an HTML offer page 406. Depending on the number of ODF files 403 to be considered, as defined in TDF file 401, appropriate HTMT template file 402, as named in TDF file 401, is selected. HTMT 402 preferably contains pre-defined tags such as “TITLE DESCRIPTION 1”. These tags are replaced by values selected using parameters of ODF file 403. An HTML generator function merges TDF 401, HTMT 402 and ODF 403 with content 404, such as text and images, at box 405 to create final HTML page 406 to be viewed by a user. This HTML generator function applies business logic to sort and display offers based on priority and business value as described above in generating HTML page 406

Turning to FIG. 5, an example of positioning offers on an HTML page, based on highest business values, in accordance with the present invention, is illustrated. 501 through 505 are example offer bundles. In this example, the offer bundles are for dial-up Internet service. ABC-dialup offer 501 has the highest business value, five-hundred, hence, it may be positioned in a prime center location 508 on HTML page 506. Two other offer page slots 507 and 509 are filled with the second highest business value offer bundles 502 and 503, respectively. As a specific example, a second most desirable location, for example, top slot 507 is assigned to DEF-dialup offer bundle 502 that has a business value of four-hundred. The least desirable page location, bottom 509 is filled by MNO-dialup offer bundle 503 due to its lower business value of three-hundred. Assuming for purposes of the present example that the TDF file upon which HTML page 506 is based may have a maximum of three offers (i.e., parameter 203 of FIG. 2A is three), offers 504 and 505 with the lowest relative business values are preferably dropped and not displayed on offers HTML page 506. Preferably if two offers, such as offers 501 and 504, happen to have same identification (i.e., field 214 in ODF file 210 in FIG. 2B), only the offer with the highest business value is displayed. In one embodiment these offers are displayed by merging offers with the same merge identifications.

What is claimed is:

1. A method for merging and presenting content information comprising:
selecting a template definition file;
reading said selected template definition file;
selecting at least one offer definition file with an extension indicated by said template definition file;
reading each of said selected at least one offer definition files;
ranking offers defined by said offer definition files; and
presenting a hypertext mark-up language page with said ranked offers to a user.

2. The method of claim 1 further comprising merging said offers based on merge identifications provided in said offer definition file of each offer.

3. The method of claim 1 further comprising filtering offers based on dynamic arbitrary attributes provided by said offer definition file.

4. The method of claim 1 further comprising determining whether all offer definition files with said extension indicated by said template definition file have been read.

5. The method of claim 4 further comprising repeating said selecting an offer definition file and said reading said selected offer definition file in response to a determination that all offer definition files have not been read.

6. The method of claim 1 further comprising determining if all of said template definition files have been read.

7. The method of claim 6 further comprising repeating, in response to a determination that all template definition files have not been read, said selecting a template definition file, said reading said selected template definition file, said selecting at least one offer definition file, said reading each of said selected offer definition files, said ranking.

8. The method of claim 1 further comprising reading an offers directory path from a configuration file of a service delivery platform application carrying out said method.

9. The method of claim 8 further comprising selecting a locale folder.

10. The method of claim 9 wherein said locale folder is in said offers directory.

11. The method of claim 9 wherein said selecting a locale folder is carried out based on a client environment.

12. The method of claim 9 wherein said selecting a locale folder is carried out based on a client location.

13. The method of claim 9 wherein said template definition file is selected from said locale folder.

14. The method of claim 1 wherein said reading of said template definition file comprises reading at least one field selected from a group of fields consisting of:
a hyper text mark-up language template filepath;
an offer definition filepath;
an offer definition file extension;
content;
a hypertext mark-up language output file name;
a maximum number of offers to display; and
replaceable text.

15. The method of claim 1 wherein said reading of said offer definition file comprises reading at least one field selected from a group of fields consisting of:
a content filepath; and
an offer business value.

16. The method of claim 1 wherein said reading of said offer definition file comprises reading at least one field selected from a group of fields consisting of:
a merge identification;
an offer display priority;
a promotion code;
at least one dynamic arbitrary filter attribute;
a partner identification;
a sweepstakes code;
a coupon code;
a type of offer;
an offer pertaining to specific product line; and
a zip code.

17. The method of claim 1 further comprising determining placement of said offers on an offer page to be displayed.

18. The method of claim 1 wherein said ranking is made based on business values of said offers.

19. The method of claim 1 further comprising selecting a hypertext mark-up language template based on a number of offers to display as indicated in said template definition file.

20. A content information merge and presentation system comprising:
at least one synchronization server;
at least one content server;
network connectivity providing data communication between at least one user device and said servers;
at least one template definition file;
at least one offer definition file;
at least one hypertext mark-up language template; and
a client service delivery platform application running on said user device, said application merging said at least one template definition file, said at least one offer definition file, and said at least one hypertext mark-up language template file, to present an offers page for display by said user device.

21. The system of claim 20 wherein said at least one synchronization server is said at least one content server.

22. The system of claim 20 wherein said merging also includes merging offers based on merge identifications provided in said offer definition file of each offer.

23. The system of claim 20 wherein said at least one offer definition file comprises, at least in part, dynamic arbitrary attributes for filtering offers by said service delivery platform.

24. The system of claim 20 wherein said template definition file comprises at least one field selected from a group of fields consisting of:
a hyper text mark-up language template filepath;
an offer definition filepath;
an offer definition file extension;
content;
a hypertext mark-up language output file name;
a maximum number of offers to display; and
replaceable text.

25. The system of claim 20 wherein said offer definition file comprises at least one field selected from a group of fields consisting of:
a content filepath; and
an offer business value.

26. The system of claim 20 wherein said offer definition file comprises at least one field selected from a group of fields consisting of:
a merge identification;
an offer display priority;
a promotion code;
at least one dynamic arbitrary filter attribute;
a partner identification;
a sweepstakes code;
a coupon code;
a type of offer;
an offer pertaining to specific product line; and
a zip code.

27. The system of claim 20 wherein said application determines placement of said offers on said offers page based on relative business values of said offers.

28. The system of claim 20 wherein said application selects said at least one hypertext mark-up language template based on a number of offers to display as indicated in said template definition file.

29. The system of claim 28 wherein said application reads an offers directory path from an associated configuration file.

30. The system of claim 29 wherein said application selects a locale folder in said offers directory.

31. The system of claim 30 wherein said selection is carried out based on a client environment.

32. The system of claim 30 wherein said selecting is carried out based on a client location.

33. The system of claim 30 wherein said template definition file is in said locale folder.

34. A method for merging content information comprising:
selecting a template definition file;
reading said selected template definition file;
selecting an offer definition file with an extension indicated by said selected template definition file;
reading said selected offer definition file;
determining whether all offer definition files with said extension indicated by said selected template definition file have been read;
repeating, in response to a determination that all offer definition files have not been read, said selecting an offer definition file and said reading said selected offer definition file;
ranking offers defined by said selected offer definition files;
writing a hypertext mark-up language output file based on said offers and said ranking;
determining if all of said template definition files have been read;
repeating, in response to a determination that all template definition files have not been read: said selecting a template definition file, said reading said selected template definition file, said selecting an offer definition file, said reading said selected offer definition file, said determining whether all offer definition files been read, said repeating said selecting and reading an offer definition file, said ranking, and said writing; and
presenting, in response to all template definition files having been read, a hypertext mark-up language page with said ranked offers.

35. The method of claim 34 wherein said selecting a template definition file is carried out based, at least in part, on a client environment.

36. The method of claim 34 wherein said selecting a template definition file is carried out based, at least in part, on a client location.

37. The method of claim 34 further comprising determining placement of said offers on an offer page to be displayed.

38. The method of claim 37 wherein said placement determination is based at least in part on business values of said offers.

39. The method of claim 34 further comprising merging said offers based on merge identifications provided in said offer definition file of each offer.

40. The method of claim 34 further comprising filtering offers based on dynamic arbitrary attributes provided by said offer definition file.

41. The method of claim 34 further comprising selecting a hypertext mark-up language template based on a number of offers to display as indicated in said template definition file.

42. The method of claim 41 wherein said presenting further comprises merging said selected template definition file, said selected offer definition file and said hypertext mark-up language template to provide said hypertext mark-up language page.

43. The method of claim 34 wherein said reading of said template definition file comprises reading at least one field selected from a group of fields consisting of:
a hyper text mark-up language template filepath;
an offer definition filepath;
an offer definition file extension;
content;
a hypertext mark-up language output file name;
a maximum number of offers to display; and
replaceable text.

44. The method of claim 34 wherein said reading of said offer definition file comprises reading at least one field selected from a group of fields consisting of:
a content filepath; and
an offer business value.

45. The method of claim 34 wherein said reading of said offer definition file comprises reading at least one field selected from a group of fields consisting of:
a merge identification;
an offer display priority;
a promotion code;
at least one dynamic arbitrary filter attribute;
a partner identification;
a sweepstakes code;
a coupon code;
a type of offer;
an offer pertaining to specific product line; and
a zip code.

46. The method of claim 34 further comprising reading an offers directory path from a configuration file of a service delivery platform application carrying out said method.

47. The method of claim 46 further comprising selecting a locale folder from said offers directory.

48. The method of claim 47 wherein said template definition file is selected from said locale folder.
